(19) United States
(12) Patent Application Publication
(10) Pub. No.: US 2017/0315515 A1
(43) Pub. Date: Nov. 2, 2017

(54) SYSTEM FOR CONTROLLING OPERATION OF A MACHINE

(71) Applicant: Caterpillar Inc., Peoria, IL (US)

(72) Inventors: Nicolas François-Xavier Christophe Vandapel, Pittsburgh, PA (US); Michael Karl Wilhelm Happold, Fox Chapel, PA (US); Syed Waqas Hassan Tirmizi, Wexford, PA (US)

(73) Assignee: Caterpillar Inc., Peoria, IL (US)

(21) Appl. No.: 15/143,881

(22) Filed: May 2, 2016

(51) Int. Cl. G05B 13/02; G05B 15/02

(52) U.S. Cl. CPC G05B 13/0205; G05B 13/0265; G05B 15/02

(57) ABSTRACT

A control system for operating a machine includes a perception system and a controller. The perception system includes sensors that generate raw data signals pertaining to characteristics of an environment associated with the machine. The perception system also includes a processor that receives the raw data signals from the sensors and determines the characteristics of the environment from the received raw data signals. The determined characteristics of the environment include at least terrain features associated with a job site, and a presence of objects in the vicinity of the machine, wherein the objects include one of: stationary objects and moving objects. The processor also determines a current operating mode of the machine. The controller is communicably coupled to the processor and is configured to actuate subsequent operation of the machine based on the current operating mode of the machine and the characteristics of the environment determined by the processor.

### TECHNICAL FIELD

The present disclosure generally relates to a system for controlling operation of a machine. More particularly, the present disclosure relates to a system for controlling operation of a machine based on future operations from a set of operations occurring substantially cyclically while such system's capabilities include learning and defining new operations into the set of operations configured for execution by the machine.

### BACKGROUND

Heavy industrial mobile machinery used in applications such as, but not limited to, construction, mining, agriculture, and forestry are typically configured to repetitively execute a set of operations in a cyclical manner. In many cases, each of these operations require different control strategies for implementation by the machine. In addition, it may also be required for the machine to learn new operations for inclusion into the set of operations for execution at a subsequent period. Until this point, many of the operations may have been carried out manually in a sequence to repetitively complete the set of cyclical operations while the machine is imparted with little or no capabilities for learning new operations. Consequently, operators of machines may sometimes find it cumbersome or may experience fatigue when manually operating the machine to repetitively execute such set of cyclical operations.

Autonomy has demonstrated some degree of success in implementing various control strategies for executing each operation from the set of cyclical operations. For reference, PCT Publication 2015/005800 discloses a control system for autonomous drilling. The control system comprises an acoustic sensor configured to provide acoustic data in near real time, a CPU and a drilling module with a steerable drilling device and a drilling motor. The CPU is configured to detect a different material based on the acoustic data, and for providing the drilling device with a directional vector independent of a priori or predefined curvature. The CPU may be disposed in the drilling module. In an alternative embodiment, the CPU is located at the surface, and the autonomous drilling is performed as a mode of operation without any human intervention or steering. Disadvantageously, autonomy with little or no assistance from one or more real-time or near real-time sensor inputs reflective of changes in the operating state of the machine or an environment associated with the machine could be minimally effective in controlling the operation of the machine.

Hence, there is a need for a control system that can be configured to accept one or more real-time or near real-time sensor inputs on the basis of various factors associated with the machine and its surroundings and co-operatively use the sensor inputs for controlling a subsequent operation of the machine.

### SUMMARY OF THE DISCLOSURE

In one aspect of the present disclosure, a control system for autonomously operating a machine in a job site includes a perception system and a controller. The perception system includes sensors that are configured to generate raw data signals pertaining to characteristics of an environment associated with the machine. The perception system also includes a processor configured to determine a current operating mode of the machine. The processor is also communicably coupled to the sensors for receiving the raw data signals from the sensors, and determining from the received raw data signals at least terrain features associated with the job site, and a presence of objects in the vicinity of the autonomous machine, wherein the objects include one of: stationary objects and moving objects. The controller is communicably coupled to the processor and configured to actuate subsequent operation of the machine based on the current operating mode of the machine and the characteristics of the environment determined by the processor.

In another aspect of the present disclosure, a machine includes a frame configured to rotatably support a plurality of ground engaging members thereon, and at least one operational system disposed on the frame. The at least one operational system could include one or more of a drive system, a steering system, a brake system, and an articulation system, each of which is configured to actuate at least one type of operation in the machine. The machine also includes a perception system having a plurality of sensors disposed on the frame. The sensors are configured to generate raw data signals pertaining to characteristics of an environment associated with the machine. The perception system also includes a processor configured to determine a current operating mode of the machine. The processor is also communicably coupled to the sensors for receiving the raw data signals from the sensors, and determining from the received raw data signals at least terrain features associated with the job site, and a presence of objects in the vicinity of the autonomous machine, wherein the objects include one of: stationary objects and moving objects. The controller is communicably coupled to the processor and configured to actuate subsequent operation of the machine via the at least one operational system based on the current operating mode of the machine and the characteristics of the environment determined by the processor.

In yet another aspect of the present disclosure, a method of controlling operation of a machine in a job site includes generating, by a plurality of sensors, raw data signals pertaining to characteristics of an environment associated with the machine. The method further includes receiving, by a processor communicably coupled to the sensors, the raw data signals pertaining to characteristics of the environment associated with the machine from the sensors. The method further includes determining, by the processor, characteristics of the environment associated with the machine from the received raw data signals, the determined characteristics of the environment including at least terrain features associated with the job site, and a presence of objects in the vicinity of the machine in which the objects include one of: stationary objects and moving objects. The method also includes determining, by the processor, a current operating mode of the machine; and actuating subsequent operation of the machine, by a controller communicably coupled to the processor, based on the current operating mode of the machine and the characteristics of the environment determined by the processor.

Other features and aspects of this disclosure will be apparent from the following description and the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is a side view of an exemplary machine being positioned in a job site, in accordance with embodiments of the present disclosure;

FIG. 2 is a schematic of a control system having a perception system and a controller for controlling operation of the exemplary machine of FIG. 1, in accordance with embodiments of the present disclosure;

FIG. 3 is a block diagram showing various interactions of the controller with components disclosed herein for performing functions in accordance with embodiments of the present disclosure;

FIG. 4 is an exemplary low-level implementation of the perception and control system of FIG. 2 for controlling operation of the exemplary machine of FIG. 1, in accordance with embodiments of the present disclosure; and

FIG. 5 is a flowchart depicting a method of controlling an operation of the exemplary machine of FIG. 1, in accordance with an embodiment of the present disclosure.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the operating systems) may not be described in detail herein. Furthermore, the connecting lines shown in the various figures contained herein are intended to represent exemplary functional relationships and/or physical/communicative couplings between the various elements. It should be noted that many alternative or additional functional relationships or physical/communicative connections may be present in a practical system.

The present disclosure is described herein with reference to system architecture, block diagrams and flowchart illustrations of methods, and computer program products according to various aspects of the disclosure. It will be understood that each functional block of the block diagrams, the flowchart illustrations, and combinations of functional blocks in the block diagrams, the flowchart illustrations, and combinations of functional blocks in the block diagrams, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce output/s that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. It should be further appreciated that the multiple steps as illustrated and described as being combined into a single step for the sake of simplicity may be expanded into multiple steps. In other cases, steps illustrated and described as single process steps may be separated into multiple steps but have been combined for simplicity.

It may be further noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in systems, modules, and methods for controlling operation of a machine. Specific nomenclature used herein is merely exemplary and only used for descriptive purposes. Hence, such nomenclature must not be construed as being limiting of the scope of the present disclosure.

The present disclosure is now described in more detail herein in terms of the above disclosed exemplary embodiments of system, methods, processes and computer program products. This is for convenience only and is not intended to limit the application of the present disclosure. In fact, after reading the following description, it will be apparent to one skilled in the relevant art(s) how to implement the following disclosure in alternative embodiments.

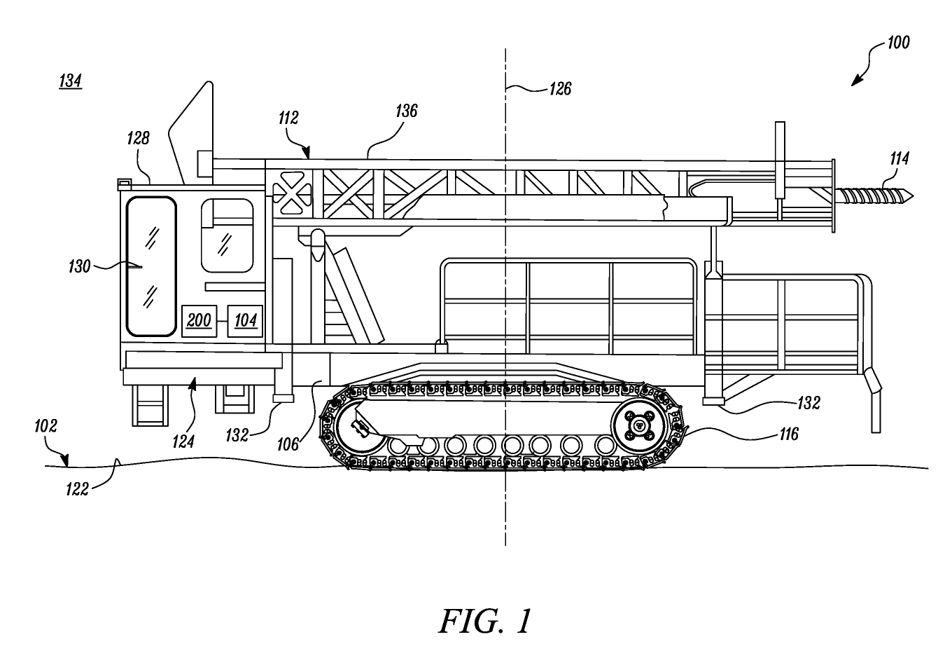

With reference to FIG. 1, an exemplary machine 100 is depicted, in which embodiments of the present disclosure may be implemented. As shown, the machine 100 is embodied in the form of a drill and is shown located on a job site 102. The machine 100 may be used in a variety of applications including mining, quarrying, road construction, construction site preparation, etc. For example, the drill of the present disclosure may be employed for penetrating earth materials such as ore, soil, debris, or other naturally occurring deposits from the job site 102; and for defining one or more openings (not shown) in such earth materials.

Although the exemplary machine 100 is embodied as a drill in the illustrated embodiment of FIG. 1, it will be appreciated that the other types of machines including, but not limited to, shovels, diggers, buckets, hydraulic excavators, motor graders, and the like can be optionally used in lieu of the drill disclosed herein to implement the embodiments of the present disclosure. Moreover, for purposes of the present disclosure, the machine 100 may be regarded as an autonomous machine. However, in alternative embodiments of the present disclosure, the machine 100 can optionally be embodied in the form of a remotely-operated machine, a manually-operated machine, or a machine that is operable in both manual and autonomous mode for e.g., a semi-autonomous mode. Therefore, notwithstanding any particular configuration of the machine 100 disclosed in this document, it may be noted that embodiments disclosed herein can be similarly applied to other types of machines without deviating from the spirit of the present disclosure.

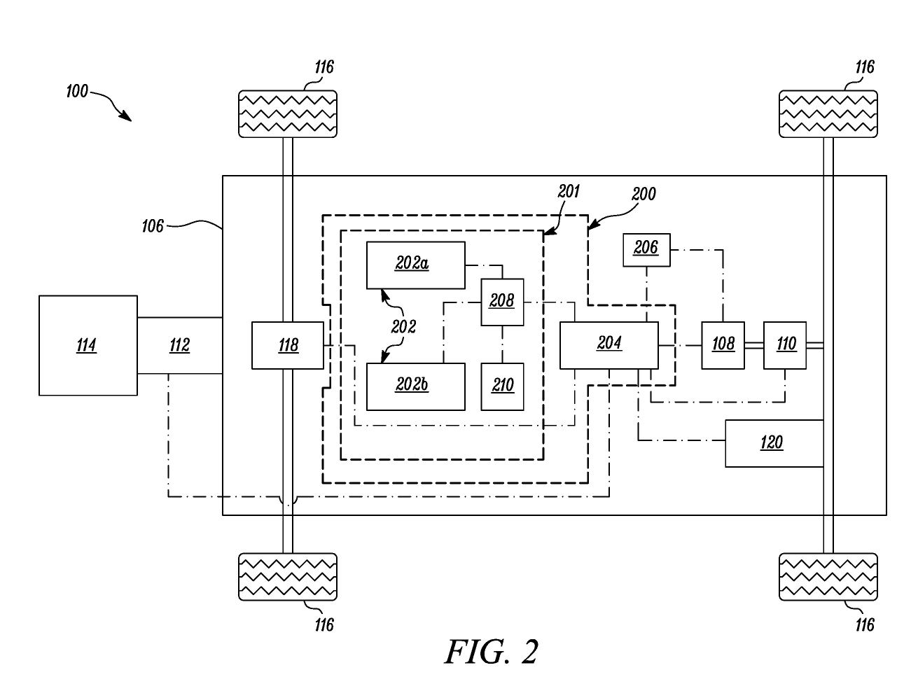

Referring to FIGS. 1 and 2, the machine 100 may include a frame 106 for supporting thereon—at least one operational system 104 of the machine 100 and multiple ground engaging members 116 for e.g., tracks as shown in FIG. 1 or wheels as shown in FIG. 2. The at least one operational system 104 disclosed herein could include a drive system 108, a transmission system 110, an articulation system 112, and a work implement 114 for e.g., a drill rig. The drive system 108 may include an engine (not shown), an electric motor for e.g., a traction motor (not shown), or both depending on specific requirements of an application. The transmission system 110 may include gears, differential systems, axles, and other components (not shown) that are coupled to the drive system 108 and the ground engaging members 116 of the machine 100. The transmission system 110 is configured to transfer power from the drive system 108 to the ground engaging members 116 and hence, propel the machine 100 on a work surface 122 of the job site 102.

The articulation system 112 may include linkages (not shown) that are coupled to the frame 106 and the work implement 114. As shown in FIG. 1, the work implement 114 is embodied in the form of a drill. However, in other embodiments, other types of work implements such as, but not limited to, blades, shovels, buckets, scrapers, and the like may be employed by the machine 100 without deviating from the spirit of the present disclosure. Moreover, as the articulation system 112 is operatively driven by the drive system 108, the articulation system 112 can initiate a movement of a drill mast 136 and the work implement 114 relative to the frame 106 of the machine 100 during operation so that the work implement 114 can be operatively raised or lowered relative to the frame 106 for perform functions including, but not limited to, drilling relative to the work surface 122 of the job site 102. Referring to FIG. 1, only one side of the machine 100 is illustrated and hence, only one ground engaging member 116 is visible. However, it should be noted that a similar ground engaging member (not shown) is present on the other side of the machine 100 as well (refer to FIG. 2). To that end, it must also be noted that the articulation system 112 disclosed herein can further include appropriate systems, mechanisms, and other movement control devices (not shown) that allow a body 124 of the machine 100 to swivel about a swivel axis 126 defined between the pair of ground engaging members 116 (refer to FIG. 1).

As shown in FIG. 1, the machine 100 may also include a cab 128 having a door 130. The door 130 may be configured to allow access to an operator for entering and exiting the cab 128. As such, the cab 128 could be sized and shaped to house an operator of the machine 100 when operating the machine 100 in a manual or a semi-autonomous mode. However, the present disclosure relates to autonomously controlling movement of the machine 100, and in particular, actuating movement of one or more operational systems 104 of the machine 100 based on various factors as will be described in detail herein.

The machine 100 includes a control system shown and generally indicated by numeral ‘200’ in FIG. 1. Further explanation pertaining to the control system 200 will now be made in conjunction with FIG. 2. Referring to FIG. 2, the control system 200 includes a perception system shown and generally indicated by numeral ‘201’.

The perception system 201 includes multiple sensors 202a, 202b (collectively hereinafter referenced by numeral ‘202’). Although two sensors 202 are shown in the illustrated embodiment of FIG. 2, in other embodiments, fewer or more number of sensors can be implemented in the perception system 201 depending on specific requirements of an application. These sensors 202 are configured to generate raw data signals pertaining to characteristics of an environment 134 associated with the machine 100 (refer to FIG. 1). In embodiments herein, the characteristics of the environment 134 associated with the machine 100 include terrain features of the job site 102 and a presence of objects in the vicinity of the machine 100, the objects including both stationary objects as well as moving objects located in the vicinity of the machine 100. As such, in embodiments of this disclosure, it may be noted that such stationary objects and moving objects also form part of the characteristics of the environment 134 associated with the machine 100. Hence, raw data signals pertaining to each of the objects, whether stationary or moving, may be generated by the sensors 202 for subsequently controlling movement of the machine 100 as will be described later herein.

In an embodiment of this disclosure, the sensors 202 could include at least one perception sensor 202a and at least one vision sensor 202b. Although one perception sensor 202a and one vision sensor 202b are shown in the illustrated embodiment of FIG. 2, the sensors 202 could include fewer or more number of each type of sensor 202a, 202b disclosed herein. As an example, the perception sensor 202a could include one or more devices such as, but not limited to, hall-effect sensors, a light detection and ranging system (LIDAR), a radio detection and ranging system (RADAR), a sound navigation and ranging system (SONAR), and the like. Additionally or optionally, the vision sensor 202b could include one or more visual cameras, but is not limited thereto. Although it is disclosed herein that the sensors 202 could include perception sensors 202a and vision sensors 202b, it should be noted that the configurations of the perception sensor 202a and the visual sensor 202b disclosed herein are merely exemplary in nature and hence, non-limiting of this disclosure. One skilled in the art will acknowledge that any type of sensors known in the art may be implemented in lieu of the perception sensor 202a and the visual sensor 202b for performing functions that are consistent with the present disclosure.

Sensors 202 disclosed herein can obtain data from the environment 134 in which the machine 100 is currently located. Subsequently, the sensors 202 can generate raw data signals pertaining to characteristics of the environment 134 associated with the machine 100. In an embodiment, the sensors 202 may generate raw data signals pertaining to terrain features associated with the job site 102. The raw data signals may generated by the sensors 202 on the basis of, for example, a contour of the job site 102 e.g., an embankment, a hill, a ridge etc. in which the machine 100 is located. In addition, the sensors 202 are also configured to generate raw data signals pertaining to the objects present in the vicinity of the machine 100. For example, the sensor 202 may generate raw data signals pertaining to an overall geometry of the objects. Such geometry could include a width, height, and length of the objects; or even a form or contour of the objects present in the vicinity of the machine 100.

As disclosed earlier herein, it is contemplated that the sensors 202 generate the raw data signals corresponding to a presence of objects on the job site 102. The sensors 202 could also generate raw data signals relating to, for example, a current location of the machine 100 and/or a distance of the machine 100 with the objects. To that end, the sensors 202 could additionally include other types of devices for e.g., an altimeter for determining other characteristics of the environment 134 for e.g., an altitude of the work surface 122 or the job site 102 on which the machine 100 is located, or an altitude of the work surface 122 or the job site 102 on which the objects are located. Such additional characteristics associated with the environment 134 may be implemented for use in appropriate computations to determine subsequent parameters of interest relating to a positioning of the machine 100, an orientation of the machine 100, and/or a location of the objects in the job site 102 with respect to the machine 100.

The perception system 201 further includes a processor 208 communicably coupled to the sensors 202 associated with the perception system 201. The processor 208 disclosed herein could embody any type of computing device that is configured to perform functions consistent with the present disclosure. Raw data signals may be transmitted by the sensors 202 to the processor 208, and subject to appropriate computation by the processor 208 for determining the characteristics of the environment 134 i.e., terrain features associated with the job site 102, and a presence of objects in the vicinity of the machine 100. The raw data signals could be provided, in real-time or near real-time, from the sensors 202 to the processor 208 for accomplishing a control in the movement of the machine 100 on the job site 102.

With continued reference to FIG. 2, the control system 200 further includes a controller 204 communicably coupled to the processor 208. As shown in FIG. 2, the controller 204 is disposed in communication with the processor 208, the drive system 108, the transmission system 110, the articulation system 112, the work implement 114, and the ground engaging members 116 of the machine 100. In addition, it is also contemplated that in embodiments of the present disclosure, the controller 204 may be further disposed in communication with a steering system 118, and a brake system 120 of the machine 100 as shown in FIG. 2. As such, the steering system 118 disclosed herein is coupled to the ground engaging members 116, and when subject to appropriate commands from the controller 204, can operatively perform a steering of the ground engaging members 116 relative to the frame 106 of the machine 100. Likewise, the brake system 120 is also operatively coupled to the ground engaging members 116, and when subject to appropriate commands from the controller 204, can retard a rotational speed of one or more ground engaging members 116.

The controller 204 is configured to actuate movement of the machine 100 based on the characteristics of the environment 134 determined by the processor 208. The controller 204 disclosed herein could include various software and/or hardware components that are configured to perform functions consistent with the present disclosure. As such, the controller 204 of the present disclosure may be a stand-alone controller or may be configured to co-operate in conjunction with an existing electronic control module (ECU) 206 of the machine 100 to perform functions consistent with the present disclosure. Further, the controller 204 may embody a single microprocessor or multiple microprocessors that include components for selectively controlling operations of the machine 100 based on sensed characteristics of the environment 134 including terrain features associated with the job site 102, and the presence of objects in the vicinity of the machine 100.

Numerous commercially available microprocessors can be configured to perform the functions of the controller 204. It should be appreciated that the controller 204 could readily be embodied in a general machine microprocessor capable of controlling numerous machine functions. The controller 204 may also include a memory (not shown), a secondary storage device, a processor, and any other components for running an application. Various other circuits may be associated with the controller 204 such as power supply circuitry, signal conditioning circuitry, solenoid driver circuitry, and other types of circuitry. Also, various routines, algorithms, and/or programs can be programmed within the processor 208 for execution at the controller 204 to control an operation of the machine 100 on the job site 102 based on the characteristics of the environment 134 determined by processor 208.

In embodiments of the present disclosure, the processor 208 is also configured with appropriate set/s of capabilities for interpreting the presence of objects as ‘obstacles’ with regards to determining a path of travel for the machine 100 by the controller 204 on the basis of the determined characteristics of the environment 134. In such embodiments, the processor 208 is further configured to determine a path of travel for the machine 100 on the basis of the detected obstacles, as represented by the objects present in the vicinity of the machine 100. For example, the sensors 202 may generate raw data signals indicative of a detection of a tree on the job site 102. Based on inputs from the processor 208, the controller 204 may correspondingly navigate the machine 100 by appropriately commanding the drive system 108, the steering system 118, the braking system, and the articulation system 112 so that the machine 100 is avoided from coming into contact or colliding with the tree on the job site 102.

It is hereby envisioned that the exemplary machine 100 shown in FIG. 1, i.e., drill would be employed on a job site for e.g., the job site 102 to perform at least two or more operations and such operations may need to be repetitively executed in a cyclical manner for accomplishing various desired tasks or functions on the job site 102. For example, with regards to the exemplary machine 100 of FIG. 1, it is envisioned that the machine 100 would need to move from a current location to a designated location on the job site 102; jack-up at the designated location on the job site 102 using an appropriate operational system for e.g., outriggers 132 (refer to FIG. 1), position the drill mast 136 and the work implement 114 to a designated position corresponding to the designated location on the job site 102, and drill the work surface 122 of the job site 102 at the designated location on the job site 102.

Moreover, the positioning of the drill mast 136 and the work implement 114 to the designated position disclosed herein could include positioning of the drill mast 136 and the work implement 114 by the controller 204 corresponding to the work surface 122 at the designated location on the job site 102. Such work surface 122 could include, but is not limited to, a horizontal work surface for e.g., a ground surface of the job site 102; a vertical work surface for e.g., a high wall of the job site 102; or any other angularly disposed work surface present on the job site 102 for e.g., an embankment, a boulder, a hill, a ridge and the like. Persons skilled in the art will acknowledge that drills typically known in the art have been configured with appropriate capabilities vis-à-vis one or more operational systems e.g., the articulation system 112 therein for also receiving appropriate commands from a user e.g., in a remotely-operated mode or a semi-autonomous mode, and for performing a positioning of the drill mast 136 and the work implement 114 and thereafter performing drilling operations on the aforesaid work surface 122 on the basis of the received commands. Therefore, for sake of brevity in this disclosure, further details pertaining to such capabilities and operations rendered by the operational systems will be omitted herein.

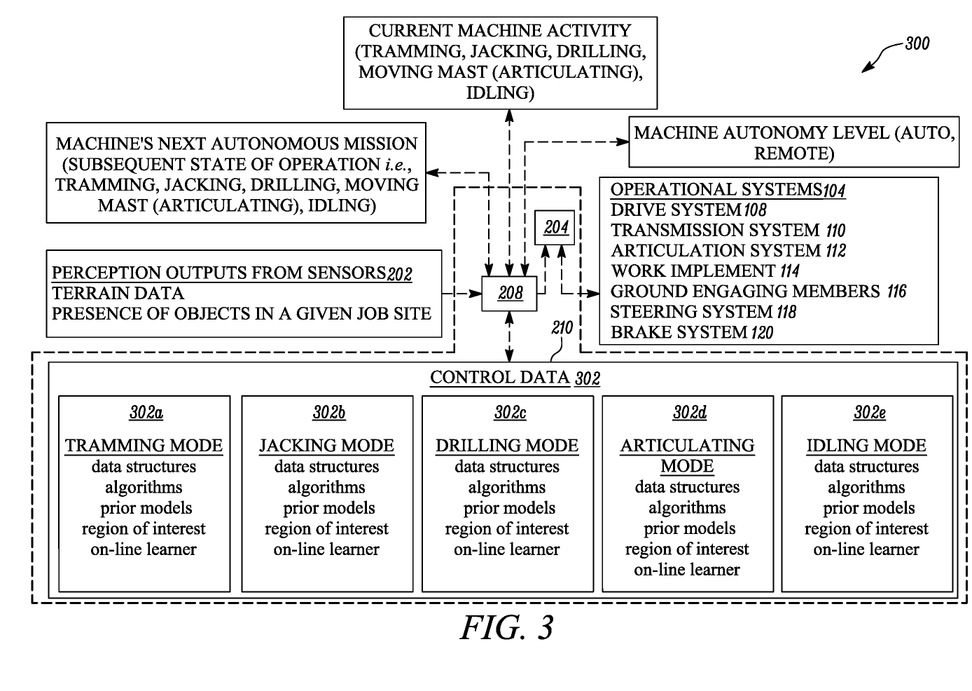

As shown in FIG. 3, the processor 208 disclosed herein is also provided with control data 302 for each operating mode of the machine 100. The control data 302 could be stored at a memory 210 associated with the processor 208. Various configurations for storing the control data 302 are well known in the art and any known configuration of storing the control data 302 may be implemented for facilitating the controller 204 to execute functions consistent with the present disclosure.

With regards to the exemplary machine 100 of FIG. 1, the operating modes for a drill would typically include a tramming mode 302a, a jacking mode 302b, a drilling mode 302c, an articulating mode 302d, and an idle state 302e as shown in FIG. 3, but is not limited thereto. Although five operating modes are disclosed herein, a number of operating modes may vary depending on a type of the machine 100, a configuration of operational systems present in the machine 100, and also based on the functions needed to be performed by the machine 100. Therefore, notwithstanding anything contained in this document, it may be noted that the processor 208 can be provided with control data corresponding to any number of operating modes of the machine 100 for use by the controller 204 depending on specific requirements of an application. Also, it may be noted that systems and methods disclosed herein can therefore be similarly applied to other types of machines known in the art without limiting the scope of the present disclosure as defined by the claims appended herein.

For each operating mode 302a-302e of the machine 100, the memory 210 may store the pre-defined control data 302 in the form of data structures, algorithms, prior models, region of interest models, and on-line learner models. In embodiments herein, the processor 208 can access the control data 302 pertaining to a current operating mode of the machine 100. For example, if the machine is tramming on the job site 102 i.e., moving from one location to another, the processor 208 could access the control data 302 associated with the tramming mode 302a based on which the controller 204 can be configured to independently control an operation of the drive system 108, the transmission system 110, the steering system 118, and the brake system 120 thereby facilitating the controller 204 in controlling a movement of the machine 100 on the job site 102.

Additionally, the processor 208 could also access the control data 302 associated with the tramming mode 302a for configuring the controller 204 to independently control an operation of the articulation system 112, and the work implement 114. It is envisioned that if the articulation system 112 and the work implement 114 disclosed herein are not appropriately positioned for executing a tramming operation by the machine 100, the controller 204 can beneficially actuate movement of the articulation system 112, and the work implement 114 in accordance with appropriate commands from the processor 208 based on control data 302 associated with the tramming mode 302b prior to initiation of the tramming operation by the controller 204 in the machine 100.

Similarly, in another example, if the machine 100 is currently executing a drilling operation on the work surface of the job site 102, the processor 208 can access the control data 302 associated with the drilling mode 302c and can therefore, configure the controller 204 to prevent one or more operational systems for e.g., the drive system 108, the transmission system 110, the steering system 118, and the brake system 120 from executing any undesired movement of the machine 100 on the job site 102.

Additionally, the processor 208 can access the control data 302 associated with the drilling mode 302c from the memory 210 to configure the controller 204 for independently controlling an operation of and positioning the articulation system 112, and the work implement 114 corresponding to the designated location on the job site 102 i.e., corresponding to the work surface 122 for e.g., a vertical, horizontal, or angularly disposed work surface 122 of the job site 102. It is hereby envisioned that if the articulation system 112 and the work implement 114 disclosed herein are not appropriately positioned for executing a drilling operation by the machine 100 at the designated location on the job site 102, the controller 204 can beneficially actuate movement of the articulation system 112, and the work implement 114 in accordance with appropriate commands from the processor 208 corresponding to the control data 302 associated with the drilling mode 302c prior to initiation of the drilling operation by the controller 204 in the machine 100.

Additionally or optionally, the processor 208 can also determine from the raw data signals provided by the sensors 202a, 202b a region of interest e.g., a space immediately adjacent the work surface 122 at which drilling is being currently carried out, and determine if a substantial amount of dust is being generated from the region of interest as a result of the drilling process. If so, the processor 208 can further access one or more control data 302 associated with the drilling mode 302c and correspondingly configure the controller 204 with such control data 302 for modulating one or more parameters e.g., a speed, time, or force associated with the work implement 114 when drilling the work surface 122 so that the controller 204 can control an operation of the work implement 114 for reducing the amount of dust being generated during the drilling process. It is hereby envisioned that in many cases, such dust, if generated, could be intrinsically characteristic of a nature of the work surface 122 in the job site 102, and/or a direct consequence of the drilling operation being performed on such work surface 122. As dust disclosed herein can possibly affect a performance of the sensors 202 for e.g., impair a visibility of the perception sensor 202 or a visibility of the vision sensor 202b; it will be appreciated that the processor 208 is also configured to store the modulated operating parameters of the work implement 114 for preventing the dust generated during the drilling process at the on-line learner model of the control data 302 in the memory 210 for the drilling mode 302c and the processor 208 can configure the controller 204 for controlling a subsequent drilling operation by the machine 100 on the given job site 102 on the basis of the modulated operating parameters stored at the memory 210.

In an embodiment of the present disclosure, the processor 208 can configure the controller 204 for autonomously preparing the various operational systems present on the machine 100 for performing subsequent operations of the machine 100. For the purposes of the present disclosure, such occurrences can be categorically classified and regarded as ‘the transition states’, wherein such transition states represent a movement of the machine from one operational state to another for e.g., from a tramming mode to a drilling mode or vice-versa. As disclosed earlier herein, many operations associated with the machine 100 may need to be performed repetitively in a cyclical manner in order to accomplish specific tasks or functions on the job site 102.

To that effect, the processor 208 can determine the respective current operational states of each operational system present in the machine and determine vis-à-vis the control data 302 at the memory 210, a course of operation/s to be subsequently performed by the machine 100. It should be noted that the memory 210 disclosed herein can store the control data 302 for any number of operational modes of the machine pertaining to a given configuration of the machine 100. Moreover, the processor 208 can access the control data 302 for defining a sequence of operations and a number of operations forming part of the sequence to the controller 204. Advantageously, the sequence of operations and/or a number of operations forming part of the sequence could also be modified by a remotely located user shown at R.H.S of the controller 204 in FIG. 3.

Moreover, in another example, the machine 100 may be required to tram from one location to another between a pair of successive drilling operations (without jacking up at either of the locations). In such cases, the processor 208 could configure the controller 204 to repetitively implement control data 302 associated with the tramming mode 302a, the articulating mode 302d, and the drilling mode 302c thus omitting the jacking-up operation for the machine 100. It may be noted that although some of the operations disclosed in embodiments herein appear to occur in a tandem manner i.e., one after the other, or with a phase-shift between successive operations; it can also be contemplated to perform several operations or set/s of operations disclosed herein in a simultaneous manner or any other manner known to one skilled in the art. For example, a set of operations that can be performed simultaneously or with a phase-shift by the machine 100 could include, but is not limited to, a tramming and articulating operation, wherein the machine 100 can tram from one location to another while also simultaneously positioning its articulation system 112 and the work implement 114 to a desired position for drilling the work surface 122 of the job site 102.

Moreover, in addition to the control data 302 for each operational mode 302a-302e disclosed herein, the processor 208 is also configured to receive inputs from the sensors 202 for controlling an operation of the machine 100. For example, when the machine 100 is tramming from one location to another and the sensors 202 detect the presence of an object in the vicinity of the machine 100, the processor 208 may interpret the detected object as an obstacle that can impede the travel of the machine 100 to the subsequent designated location and accordingly issue appropriate commands for independently controlling an operation of the drive system 108, the transmission system 110, the steering system 118, and the brake system 120 and therefore, control a movement of the machine 100 on the job site 102. Hence, it may be noted that the processor 208 disclosed herein may be beneficially implemented with suitable algorithms/software/look-up tables/trial runs/test data/experimental data and the like to determine the path of travel for the machine 100 and thereafter, configure the controller 204 to navigate the machine 100 in accordance with the determined path of travel for the machine 100.

Although the drive system 108, the steering system 118, the braking system, and the articulation system 112 are disclosed herein, it should be noted that the machine 100 could, additionally or optionally, include various other operational systems other than that described above, and explanation to such operational systems may have been omitted for the sake of brevity in this document, and also for the sake of simplicity in understanding the present disclosure. However, it is to be noted that such operational systems of the machine 100 can also be disposed in communication with the controller 204 for controlling an operation of such operational systems and therefore, assist in controlling an operation of the machine 100.

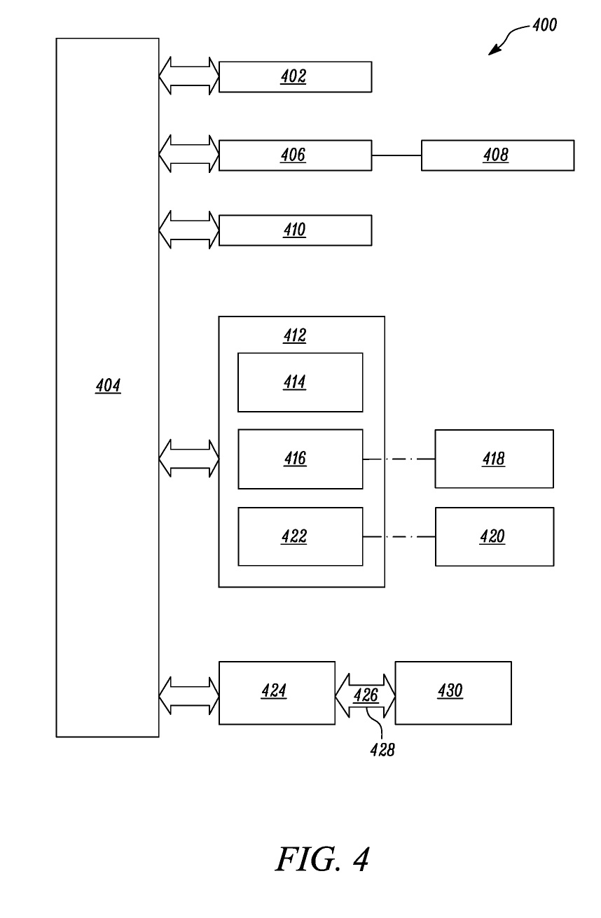

FIG. 4 is an exemplary low-level implementation of the perception system 201 and the control system 200 from FIG. 2 for controlling operation of the exemplary machine 100 of FIG. 1 in accordance with embodiments of the present disclosure. For the sake of simplicity in this document, the low-level implementation of the perception system 201 and the control system 200 will hereinafter be referred to as ‘a computer system’ and designated with similar reference numeral increased by 200 i.e., reference numeral ‘400’).

The present disclosure has been described herein in terms of functional block components, modules, and various processing steps. It should be appreciated that such functional blocks may be realized by any number of hardware and/or software components configured to perform the specified functions. For example, the processor 208 of the perception system 201 may employ various integrated circuit components, e.g., memory elements, processing elements, logic elements, look-up tables, and/or the like, which may carry out a variety of functions under the control of one or more microprocessors or other control devices. Similarly, the software elements of the system 400 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system 400 may employ any number of conventional techniques for data transmission, signaling, data processing, network control, and/or the like. Still further, the system 400 could be configured to detect or prevent security issues with a user-side scripting language, such as JavaScript, VBScript or the like. In an embodiment of the present disclosure, the networking architecture between components of the system 400 may be implemented by way of a client-server architecture. In an additional embodiment of this disclosure, the client-server architecture may be built on a customizable .Net (dot-Net) platform. However, it may be apparent to a person ordinarily skilled in the art that various other software frameworks may be utilized to build the client-server architecture between components of the perception system 201 and the controller 204 without departing from the spirit and scope of the disclosure.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., system 200, system 400, method 500, any part(s) or function(s) thereof) may be implemented using hardware, software or a combination thereof, and may be implemented in one or more computer systems or other processing systems. However, the manipulations performed by the present disclosure were often referred to in terms such as detecting, determining, and the like, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices. As such, the functions of the perception system 201 and the controller 204 can be applied for execution in the machine 100 regardless of the machine's level of automation, such levels of automation including, but not limited to, an operator assisted mode, a remotely operated mode, a supervised mode, or a fully autonomous mode.

In accordance with an embodiment of the present disclosure, the present disclosure is directed towards one or more computer systems capable of carrying out the functionality described herein. An example of the computer based system includes the computer system 400, which is shown by way of a block diagram in FIG. 3.

Computer system 400 includes at least one processor, such as a processor 402. Processor 402 may be connected to a communication infrastructure 404, for example, a communications bus, a cross-over bar, a network, and the like. Various software embodiments are described in terms of this exemplary computer system 400. Upon perusal of the present description, it will become apparent to a person skilled in the relevant art(s) how to implement the present disclosure using other computer systems and/or architectures.

Computer system 400 includes a display interface 406 that forwards graphics, text, and other data from communication infrastructure 404 for display on a display unit 408. In an embodiment, the display interface and/or unit 406, 408 could be beneficially embodied in the form of a Graphical User Interface (GUI) or other equivalent devices capable of receiving user commands. Such display interface and/or unit 406, 408 could also be located at a remote operator station (not shown) for facilitating a remotely located operator to perform functions such as, but not limited to, changing a type or configuration of one or more operating modes for the given configuration of the machine 100, for changing the order of operating modes in a given sequence for subsequent control of operation of the machine 100.

Computer system 400 further includes a main memory 410, such as random access memory (RAM), and may also include a secondary memory 412. Secondary memory 412 may further include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a well-known manner. Removable storage unit 418 may represent a floppy disk, magnetic tape or an optical disk, and may be read by and written to by removable storage drive 416. As will be appreciated, removable storage unit 418 includes a computer usable storage medium having stored therein, computer software and/or data.

In accordance with various embodiments of the present disclosure, secondary memory 412 may include other similar devices for allowing computer programs or other instructions to be loaded into computer system 400. Such devices may include, for example, a removable storage unit 420, and an interface 422. Examples of such may include a program cartridge and cartridge interface (such as that found in video game devices), a removable memory chip (such as an erasable programmable read only memory (EPROM), or programmable read only memory (PROM)) and associated socket, and other removable storage units 420 and interfaces 422, which allow software and data to be transferred from removable storage unit 420 to computer system 400.

Computer system 400 may further include a communication interface 424. Communication interface 424 allows software and data to be transferred between computer system 400 and external devices 330. Examples of communication interface 424 include, but may not be limited to a modem, a network interface (such as an Ethernet card), a communications port, a Personal Computer Memory Card International Association (PCMCIA) slot and card, and the like. Software and data transferred via communication interface 424 may be in the form of a plurality of signals, hereinafter referred to as signals 426, which may be electronic, electromagnetic, optical or other signals capable of being received by communication interface 424. Signals 426 may be provided to communication interface 424 via a communication path (e.g., channel) 428. Communication path 428 carries signals 426 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 416, a hard disk installed in hard disk drive 414, signals 426, and the like. These computer program products provide software to the computer system 400. The present disclosure is also directed to such computer program products.

Computer programs (also referred to as computer control logic) may be stored in main memory 410 and/or secondary memory 412. Computer programs may also be received via the communication interface 404. Such computer programs, when executed, enable computer system 400 to perform the functions consistent with the present disclosure, as discussed herein. In particular, the computer programs, when executed, enable processor 402 to perform the features of the present disclosure. Accordingly, such computer programs may represent controllers of computer system 400.

In accordance with an embodiment of the present disclosure, where the disclosure is implemented using a software, the software may be stored in a computer program product and loaded into computer system 400 using removable storage drive 416, hard disk drive 414 or communication interface 424. The control logic (software), when executed by processor 402, causes processor 402 to perform the functions of the present disclosure as described herein.

In another embodiment, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

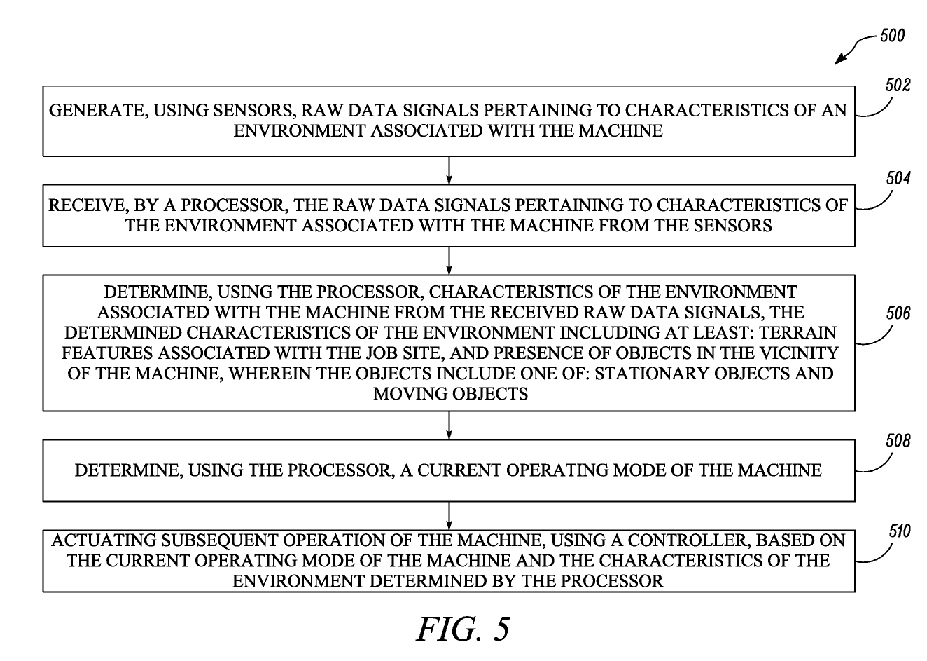

FIG. 5 is a flowchart illustrating a method 500 for controlling an operation of a machine for e.g., the machine 100, in accordance with an embodiment of the present disclosure.

At step 502, the method 500 includes generating, by the sensors 202, raw data signals pertaining to characteristics of the environment 134 associated with the machine 100. At step 504, the method 500 further includes receiving, by the processor 208, the raw data signals pertaining to characteristics of the environment 134 associated with the machine 100 from the sensors 202.

At step 506, the method 500 further includes determining, by the processor 208, characteristics of the environment 134 associated with the machine 100 from the received raw data signals, the determined characteristics of the environment 134 including at least terrain features associated with the job site 102, and a presence of objects in the vicinity of the machine 100. As disclosed earlier herein, the objects may include stationary objects and moving objects in the vicinity of the machine 100.

Also, in an embodiment of this disclosure, upon determination of the characteristics of the environment 134 associated with the machine 100, the method 500 can further include determining, by the controller 204, the path of travel for the machine 100 for executing a tramming operation on the basis of the determined characteristics of the environment 134 and also on the basis of the control data 302 associated with the tramming mode 302a of the machine 100.

At step 508, the method also includes determining, by the processor 208, a current operating mode of the machine 100. Thereafter, at step 510, the method 500 further includes actuating subsequent operation of the machine 100, by the controller 204, based on the current operating mode of the machine 100 and the characteristics of the environment 134, each of which is determined by the processor 208.

Embodiments of the present disclosure have applicability for use and implementation in autonomously controlling an operation of the machine based, at least in part, on characteristics of an environment associated with the machine. More particularly, embodiments of the present disclosure relate to autonomously controlling a subsequent operation of the machine on the basis of the current operational state of the machine and the characteristics of an environment associated with the machine.

In embodiments disclosed herein, the processor 208, with the help of raw data signals from the sensors 202, can determine the terrain features associated with the job site 102, and also determine the presence of the objects in the vicinity of the machine 100. Moreover, the processor 208 is provided with control data 302 pertaining individually to each operational mode 302a-302e of the machine 100. The processor 208 can access the control data 302 and configure the controller 204 on the basis of the control data 302 for a respective one of the operational modes 302a-302e so that the controller 204 can appropriately control an operation of the machine 100. Therefore, the controller 204 disclosed herein can control an operation of the machine 100 on the job site 102 on the basis of real-time or near real-time inputs from the sensors 202 and the control data 302 from the memory 210 being received at the processor 208, wherein the control data 302 is being obtained at least on the basis of the current operational state of the machine for controlling a subsequent operation of the machine 100.

With use of embodiments disclosed herein, various machines known in the art can be configured to operate on the basis of the determined characteristics of the environment, a current operating state of the machine, and one or more control data pertaining to the current and subsequent operational modes of the machine.

With implementation of embodiments disclosed herein, several machines known to persons skilled in the art can be beneficially rendered autonomous with regards to the functions required on a given job site. With regards to the drilling industry, use of embodiments disclosed herein can assist many vendors to entail reduced costs, at least in part, due to the autonomous operation of drills on a given job site.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control system for autonomously operating a machine in a job site, the control system comprising:
a perception system comprising:
a plurality of sensors configured to generate raw data signals pertaining to characteristics of an environment associated with the machine;
a processor configured to determine a current operating mode of the machine, the processor being communicably coupled to the sensors for receiving the raw data signals from the sensors, and determining from the received raw data signals at least:
terrain features associated with the job site, and
presence of objects in the vicinity of the autonomous machine, wherein the objects include one of: stationary objects and moving objects; and
a controller communicably coupled to the processor, the controller configured to actuate subsequent operation of the machine based on the current operating mode of the machine and the characteristics of the environment determined by the processor.

2. The perception system of claim 1, wherein the current operating mode of the machine being determined by the processor includes one of:
a tramming mode, wherein the machine is moving from one location to another location in the job site;
a jacking mode, wherein one or more actuators associated with the machine are configured to elevate the machine relative to a work surface of the job site;
a drilling mode, wherein a drill associated with the machine is configured to drill into the work surface of the job site;
an articulating mode, wherein an articulation linkage associated with the machine is being moved relative to the work surface of the job site; and
an idling state of the machine.

3. The control system of claim 2, wherein the processor is configured to determine if the machine is transitioning from one operating mode to another.

4. The control system of claim 2, wherein the processor is provided with pre-defined control data corresponding to each operating mode of the machine.

5. The control system of claim 4, wherein the pre-defined control data is stored at a memory associated with the processor, the control data being stored in the form of at least data structures, maps, algorithms, test models, region of interest models, and on-line learner models corresponding to each operating mode of the machine.

6. The control system of claim 4, wherein the controller is configured to use the pre-defined control data corresponding to at least one operating mode of the machine for actuating subsequent operation of the machine.

7. A machine comprising:
a frame configured to rotatably support a plurality of ground engaging members thereon;
at least one operational system disposed on the frame, the at least one operational system being configured to actuate at least one type of operation in the machine;
a perception system comprising:
a plurality of sensors disposed on the frame, the plurality of sensors being configured to generate raw data signals pertaining to characteristics of an environment associated with the machine;
a processor configured to determine a current operating mode of the machine, the processor being communicably coupled to the sensors for receiving the raw data signals from the sensors, and determining from the received raw data signals at least:
terrain features associated with the job site, and
presence of objects in the vicinity of the autonomous machine, wherein the objects include one of: stationary objects and moving objects; and
a controller communicably coupled to the processor, the controller configured to actuate subsequent operation of the machine via the at least one operational system based on the current operating mode of the machine and the characteristics of the environment determined by the processor.

8. The machine of claim 7, wherein the operational systems associated with the machine include at least one of:
a drive system coupled to the ground engaging members and configured to operatively rotate the ground engaging members;
a steering system coupled to the ground engaging members and configured to operatively allow a steering of the ground engaging members relative to the frame of the machine;
a brake system coupled to the ground engaging members and configured to operatively retard a rotational speed of the ground engaging members;
an articulation system coupled to the frame and operatively driven by the drive system, the articulation system configured to articulate:
a work implement of the machine relative to the frame of the machine, the work implement being pivotally supported on an articulation linkage of the machine; and
a body of the machine to swivel about a swivel axis of the machine.

9. The machine of claim 7, wherein the controller is communicably coupled with each of: the drive system, the steering system, the brake system, and the articulation system; the controller being configured to selectively control an operation of the drive system, the steering system, the brake system, and the articulation system based on the current operating mode of the machine and the characteristics of the environment determined by the processor.

10. The machine of claim 8, wherein the current operating mode of the machine being determined by the processor includes one of:
a tramming mode, wherein the machine is moving from one location to another location in the job site;
a jacking mode, wherein one or more actuators associated with the machine are configured to vary a height of the machine relative to a work surface of the job site;
a drilling mode, wherein a drill associated with the machine is configured to drill into the work surface of the job site;
an articulating mode, wherein an articulation linkage associated with the machine is being moved relative to the work surface of the job site; and
an idling state of the machine.

11. The machine of claim 10, wherein the processor is configured to determine if the machine is transitioning from one operating mode to another.

12. The machine of claim 10, wherein the processor is provided with pre-defined control data corresponding to each operating mode of the machine.

13. The machine of claim 12, wherein the pre-defined control data is stored at a memory associated with the processor, the control data being stored in the form of at least data structures, maps, algorithms, test models, region of interest models, and on-line learner models corresponding to each operating mode of the machine.

14. The machine of claim 12, wherein the controller is configured to use the pre-defined control data corresponding to at least one operating mode of the machine for actuating subsequent operation of the machine

15. A method of controlling operation of a machine in a job site, the method comprising:
generating, by a plurality of sensors, raw data signals pertaining to characteristics of an environment associated with the machine;
receiving, by a processor communicably coupled to the sensors, the raw data signals pertaining to characteristics of the environment associated with the machine from the sensors;
determining, by the processor, characteristics of the environment associated with the machine from the received raw data signals, the determined characteristics of the environment including at least:
terrain features associated with the job site, and
presence of objects in the vicinity of the machine, wherein the objects include one of: stationary objects and moving objects; and
determining, by the processor, a current operating mode of the machine; and
actuating subsequent operation of the machine, by a controller communicably coupled to the processor, based on the current operating mode of the machine and the characteristics of the environment determined by the processor.

16. The method of claim 15, wherein the current operating mode of the machine being determined by the processor includes one of:
a tramming mode, wherein the machine is moving from one location to another location in the job site;
a jacking mode, wherein one or more actuators associated with the machine are configured to elevate the machine relative to a work surface of the job site;
a drilling mode, wherein a drill associated with the machine is configured to drill into the work surface of the job site;
a mast-operating mode, wherein a mast associated with the drill of the machine is being moved relative to the work surface of the job site; and
an idling state of the machine.

17. The method of claim 16 further comprising, determining, by the processor, if the machine is transitioning from one operating mode to another.

18. The method of claim 16, wherein the processor is provided with pre-defined control data corresponding to each operating mode of the machine.

19. The method of claim 18, wherein the pre-defined control data is stored at a memory associated with the processor, the control data being stored in the form of at least data structures, maps, algorithms, test models, region of interest models, and on-line learner models corresponding to each operating mode of the machine.

20. The method of claim 18 further comprising using, by the controller, the pre-defined control data corresponding to at least one operating mode of the machine vis-à-vis one or more operational systems associated with the machine for actuating subsequent operation of the machine.
